(19) United States
(12) Patent Application Publication
(10) Pub. No.: US 2010/0066677 A1
(43) Pub. Date: Mar. 18, 2010

(54) Computer Peripheral Device Used for Communication and as a Pointing Device

(76) Inventors: Peter Garrett, Aptos, CA (US); Paul Regen, Felton, CA (US)

Correspondence Address: CENTRAL COAST PATENT AGENCY, INC, 3 HANGAR WAY SUITE D, WATSONVILLE, CA, 95076, US

(21) Appl. No.: 12/559,671

(22) Filed: Sep. 15, 2009

Related U.S. Application Data
(60) Provisional application No. 61/097,346, filed on Sep. 16, 2008.

(51) Int. Cl. G06F 3/033; H04N 5/225

(52) U.S. Cl. 345/163; 348/207.1; 345/173; 348/360; 348/E05.024

(57) ABSTRACT

A computer peripheral device used for communication and computing input is provided comprising a digital medium for storing data and software, a processor for controlling computing functions, a power source, a motion detection sensor, communication software residing on and executable from the digital medium, computing input device software residing on and executable from the digital medium, a user interface for enabling user control and task performance, and a wireless transceiver for enabling wireless communication.

### CROSS-REFERENCE TO RELATED DOCUMENTS

The present application claims priority to provisional application Ser. No. 61/097,346, filed on Sep. 16, 2008. The entire disclosure of provisional application Ser. No. 61/097,346 is incorporated it its entirety at least by reference.

### BACKGROUND OF THE INVENTION

1. Field of the Invention

The present invention is in the field of electronics including computer input or pointing devices and pertains particularly to methods and apparatus for providing computer control input using a peripheral communication device adapted for the purpose.

2. Discussion of the State of the Art

In the field of digital electronics including computerized appliances, there are many specialized devices that provide certain functions in a computing environment. A Smartphone is a third generation (3G) communications device (soon to be 4^{th} generation) capable of computing. A Smartphone typically has a mini operating system and computing platform and can be used as a telephone and as an Internet capable appliance as well as a multimedia device capable of recording and playing music. Most Smartphone systems are equipped with digital cameras for taking photographs and videos and include smart cards and/or universal serial bus (USB) interfaces for coupling to a computer to upload or download photos, music files, or video files.

It is well known that computers including laptops require some sort of pointing device to provide computing control input such as a mouse, trackball, touchpad, or the like. In a computing environment it can be difficult to operate a computer while simultaneously manning a communication device like a Smartphone for example. Although a Smartphone can be coupled to a computer or laptop, the capabilities afforded by the coupling are quite limited to such tasks as uploading or downloading files, syncing contact lists or calendar appointments and other mundane tasks.

Therefore, what is clearly needed is a computer peripheral device that can be used for communication, multimedia functions, and as a computing control input device or “pointing device”. Such as device would reduce the work associated with multi-device computing.

### SUMMARY OF THE INVENTION

The problem stated above is that it is desirable in a communication and computing environment to reduce complexity and work associated with computing and communication tasks, but many of the conventional means for communicating and providing computing control and input, such as cell phones and computer mice, also create more work especially when simultaneously used. The inventors therefore considered functional elements of a computing input (pointing) device and a digital communication device, looking for elements that exhibit interoperability that could potentially be harnessed to provide communication and computer pointing input capability but in a manner that would not create extra work or complexity.

Every digital communication and computing environment is enabled by communication tools and computing input capabilities, one by-product of which is an abundance of manual movements required to operate communication and pointing devices simultaneously. Most such communication and computing environments employ communication tools and computer peripheral devices to manage tasks and provide fulfillment for customers and concise collaboration for colleagues, and telephones and peripheral computing pointing devices are typically a part of such apparatus.

The present inventors realized in an inventive moment that if, multiple computing input and communication tasks could be performed from a single computer peripheral device, significant task reduction and time saving might result. The inventors therefore constructed a unique computer peripheral device for communicating with the outside world and for performing computer input tasks that allowed a user to simultaneously converse and provide computing input through a single interface. As a result, a significant reduction in work is achieved, with no impediment to communication and no additional computing input processes are created.

Accordingly, in an embodiment of the present invention, a computer peripheral device used for communication and computing input is provided comprising a digital medium for storing data and software, a processor for controlling computing functions,

a power source, a motion detection sensor, communication software residing on and executable from the digital medium, computing input device software residing on and executable from the digital medium, a user interface for enabling user control and task performance, and a wireless transceiver for enabling wireless communication.

In one embodiment the computing input device software enables a wireless mouse feature for operating a host computer. In this embodiment the communication software enables cellular telephony and Internet navigation. In a variation of this embodiment the user interface is a touch screen.

In one embodiment the computer peripheral device further includes at least two physical mouse-click buttons and a scroll button. In one embodiment the computer peripheral device further includes a retractable universal serial bus connector. In a variation of this embodiment the USB connecter is detachable from the device for use as a USB wireless transmitter.

In one embodiment the computer peripheral device further includes a digital camera device. In a variation of this embodiment the motion detection device and the digital camera device share one or more components.

In one embodiment wherein the device has a touch screen, host computing application command shortcuts are present and operate from the touch screen. In a variation of this embodiment the touch screen supports a graphic simulation of the physical controls of a computer mouse, the graphics operable to provide computing input. In another variation of this embodiment decorative graphics residing on the digital medium can be used to dress the graphic simulation of the computer mouse controls on the touch screen.

In one embodiment the computer peripheral device further includes a pop-out stand. In one embodiment wherein the device has a touch screen word processing command shortcuts can be placed on the touch screen and may be operated to perform tasks within a word processing application running on a connected computing system. Also in this embodiment multimedia device command shortcuts can be placed on the touch screen and may be operated to perform tasks relative to multimedia devices operating as host devices. In this embodiment the multimedia operation tasks include but are not limited to controlling volume level, switching from speaker to headset, and switching play from one multimedia device to another multimedia device. According to another variation of this embodiment the touch screen mirrors the active monitor display of a host computing device enabling touch screen navigation of the computer via the touch screen.

In one embodiment the computer peripheral device further includes a separate software program installable on the host computer for detecting incoming calls to the computer peripheral device and changing volume settings of multimedia devices to accommodate the call. In one embodiment wherein the computer peripheral device includes a digital camera, includes an extra convex lens movable into the line of sight of the camera lens for shortening the focal length of the camera to read surface movement in mouse operation mode. In one embodiment wherein a USB capability is provided the USB head is attached to one of a flexible, retractable neck or a retractable cord.

### BRIEF DESCRIPTION OF THE DRAWING FIGURES

FIG. 1 is a front view of a computer peripheral device paired with a computer according to an embodiment of the present invention.

FIG. 2 is a front view of the peripheral computer device of FIG. 1 with graphic mouse controls on the touch screen according to an embodiment of the present invention.

FIG. 3 is a front view of a computer peripheral device according to another embodiment of the present invention.

FIG. 4 is a rear view of the computer peripheral device of FIG. 1 or FIG. 3 according to an embodiment of the present invention.

FIG. 5 is a front view of the computer peripheral device of FIG. 1 exhibiting a decorative touch screen according to an embodiment of the present invention.

FIG. 6 is a front view of the computer peripheral device of FIG. 1 exhibiting a custom decorative touch screen according to an embodiment of the present invention.

FIG. 7 is a rear view of a computer peripheral device with a slidable optic lens in neutral position according to an embodiment of the present invention.

FIG. 8 is a rear view of the computer peripheral device of FIG. 7 with the slidable lens in alignment with the camera lens according to an embodiment of the present invention.

FIG. 9 is a block diagram illustrating convergence of focal lines to a focal point after passing through a convex lens according to an embodiment of the present invention.

FIG. 10 is a rear perspective view of a computer peripheral device with a pop out stand according to an embodiment of the present invention.

FIG. 11 is a perspective view of a computer peripheral device with a flexible USB connector attached according to an embodiment of the present invention.

FIG. 12 is a perspective view of the computer peripheral device of FIG. 11 with a flexible USB connector according to another embodiment of the present invention.

FIG. 13 is a perspective partial view of the USB flex connector of FIG. 11 with a detachable USB head that serves as a wireless USB transmitter according to an embodiment of the present invention.

FIG. 14 is a partial perspective view of the flexible USB connector of FIG. 12 with a detachable USB head that serves as a wireless USB transmitter according to another embodiment of the present invention.

FIG. 15 is a perspective view of a laptop computer running a graphical user interface (GUI) for accepting caller contact and identification data from the computer peripheral device of FIG. 1 according to an embodiment of the present invention.

FIG. 16 is an exemplary screenshot of a GUI 1600 for managing incoming calls according to an embodiment of the present invention.

FIG. 17 is a process flow chart illustrating steps for managing an incoming call to a computer peripheral device on a host computer according to an embodiment of the present invention.

FIG. 18 is a block diagram illustrating basic components of a computer peripheral device adapted for provision of computer control input according to an embodiment of the present invention.

### DETAILED DESCRIPTION

The inventors provide a unique computer peripheral device adapted as a sophisticated communication device and as a pointing device for controlling the computer. The present invention is described in enabling detail using the following examples, which may represent more than one possible embodiment.

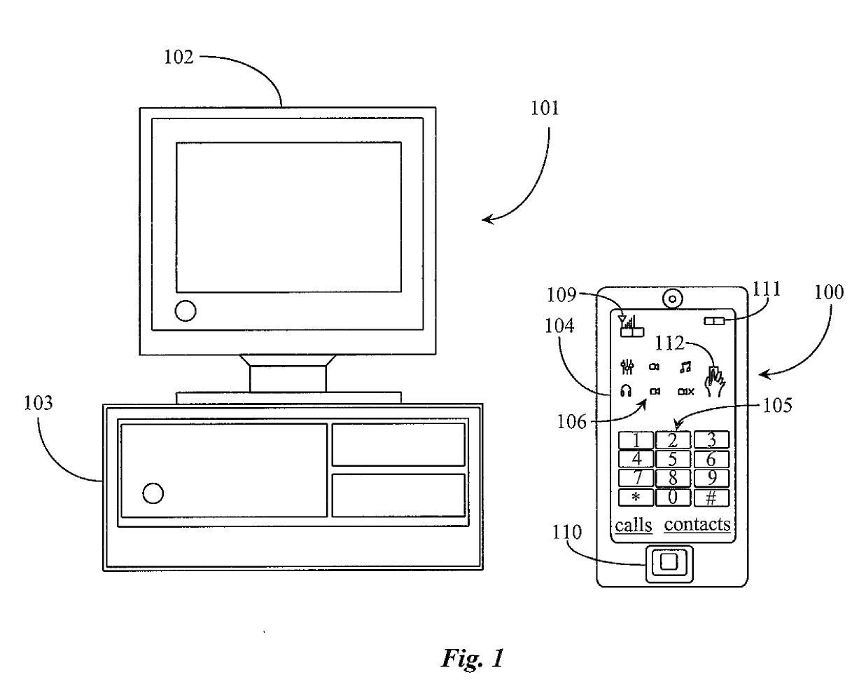

FIG. 1 is a front view of a computer peripheral device 100 paired with a computer 101 according to an embodiment of the present invention. Computer peripheral device 100 is a Smartphone having capacity for computing, communication over cellular and digital networks, and for serving as an Internet capable appliance. Smartphone 100 has a touch screen 104 that includes a representation of a keypad 105 for dialing telephone numbers. Touch screen 104 includes interactive options for viewing and selecting telephone contacts and for reviewing call history.

Touch screen 104 includes familiar icons for reporting connection status 109 and for reporting battery charge state 111. Smartphone 100 is also a multimedia-capable device and has a speaker 110 for enabling sound when playing audio. Touch screen 104 has a number of familiar shortcuts 106 displayed thereon such as shortcuts to a music player, a headset, and one or more volume controls associated with the device or with one or more connected multimedia devices that the Smartphone may be paired with or otherwise might have control access to.

In a preferred embodiment of the present invention, Smartphone 100 functions as a computer peripheral to computer 101 meaning that it communicates with the computer and is coupled thereto according to one of several known wireless communication protocols such as Bluetooth™, Ultra-wideband (UWB), or Wireless USB (WUSB). In one embodiment Smartphone 100 has a high-speed USB connector for coupling to computer 101 via a USB port. The coupling may make use of a USB cable or a unique USB flexible connector. Such USB components are illustrated in detail later in this specification.

Touch screen 104 includes a unique icon 112 for enabling a pointing device function built into Smartphone 100. Icon 112 shows a hand using the Smartphone as a computer mouse in this example. Smartphone 100 may be paired wirelessly with computer 101 so that the computer peripheral device may be used as a pointing device to control the computer. Computer 101 includes a processor base 103 and a computer monitor 102. Computer 101 may also be a notebook or laptop computer without departing from the spirit and scope of the present invention. In this example Smartphone 100 has touch screen 104 that enables a user to select icon 112 thereby activating the pointing device function built into the device so that the computer peripheral device can be used as a computer mouse. In this embodiment activation of touch screen icon 112 initiates pointing device mode and causes an interactive graphic representation (not illustrated) featuring traditional and operable mouse controls to appear on the touch screen such as a right click function, a left click function, and a scrolling function.

Touch screen 104 is not specifically required to practice the invention as Smartphone 100 may also, in one embodiment, be provided with physical pointing device controls such as those described above and a physical keypad for entering telephone numbers and so on. Touch screen 104 may be provided using any of several known touch screen technologies like resistive, capacitive, or surface wave technologies and the required materials adapted for the purpose of enabling touch screen interaction.

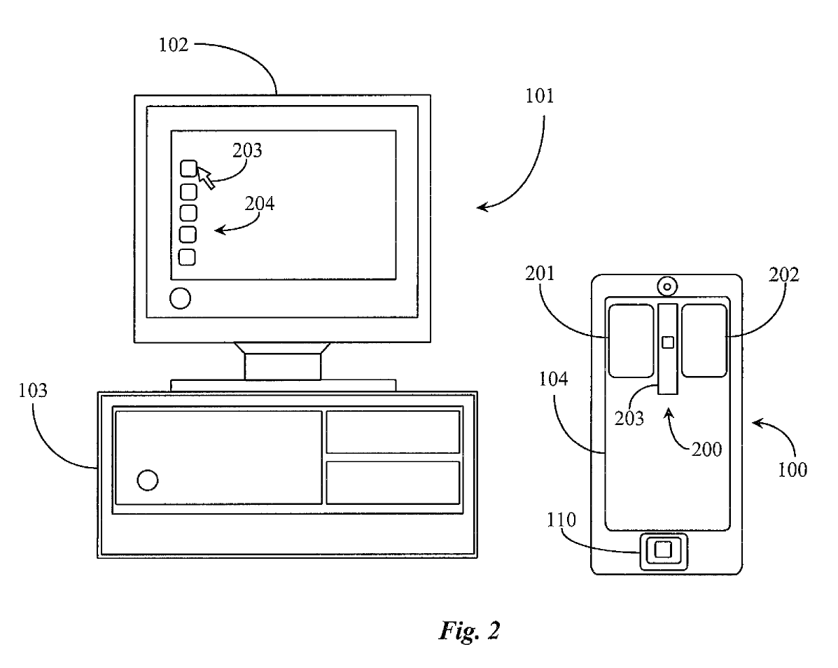

FIG. 2 is a front view of peripheral computer device 100 of FIG. 1 with graphic mouse controls 200 on the touch screen according to an embodiment of the present invention. Smartphone 100 is enabled for function as a computer mouse in this example. By activating the computer mouse icon 112 described above, touch screen 104 displays graphic mouse controls 200. Mouse controls 200 operate much like physical mouse controls would operate accept that a user interacts with the controls by touching them on the touch screen. Graphical mouse controls 200 include a right click graphic 202, a left click graphic 201, and a scroll wheel or scroll bar graphic 203.

A user may then use computer peripheral device 100 as a computer mouse as long as it is in close proximity to computer 101. A pointer 205 appears on the monitor of computer 101 when device 100 is in computer control input mode (digital mouse mode). A user may navigate through computer shortcuts 204 selecting one for execution using normal simulated mouse function using touch screen 104 and controls 200 as a mouse interface. All of the commands are transmitted wirelessly from device 100 to computer 101 using a wireless communication protocol in a preferred example. All other normal pointing device input capabilities are presumed in this example.

In another embodiment of the present invention, touch screen 104 with the aid of software can be configured to mirror the computer screen of computer 101 enabling touch screen control of the computers desktop and executed applications without using any physical or graphics mouse controls. In this embodiment everything that appears on the computer screen also appears on the touch screen. The Smart phone may mirror the screen/monitor of any computer or multimedia system that it is paired with. This allows the user to simply navigate the screen or monitor of the host system by moving their finger or a stylus across the surface of the touch screen without having to physically lay the Smartphone down on a surface area to read movement via optical sensor as previously described. The described feature essentially turns the Smartphone into a wireless touch screen for use with any screen that the Smartphone can pair with wirelessly such as a computer screen or even a TV screen.

In one embodiment shortcuts from the desktop of computer 101 may be duplicated on touch screen 104 such that they may be executed from the touch screen and run on the computer. The shortcuts may be executed by finger or stylus and may include selected shortcuts that are programmed to work with applications that are open on the computer such as command shortcuts for controls in word processing programs and the like where the shortcuts are generic to certain common operations performed in those applications such as cut, copy, paste, and save controls or the like.

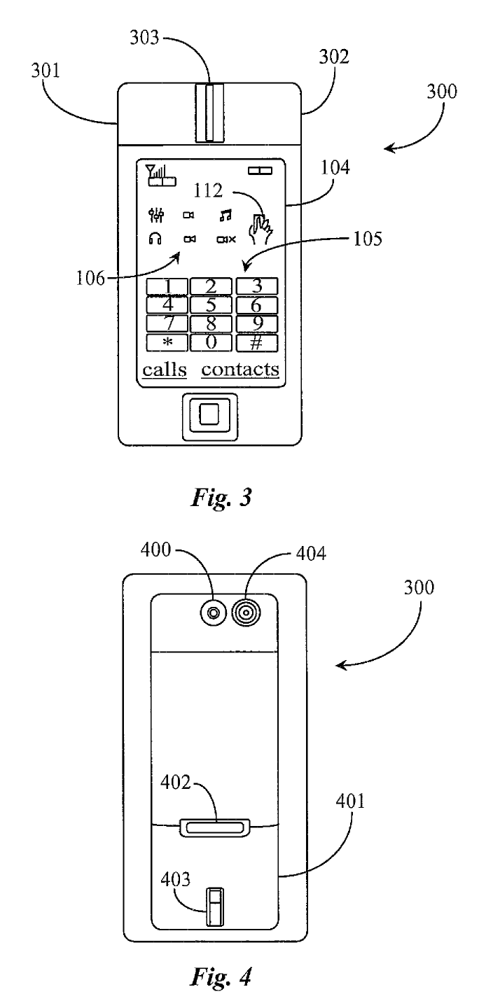

FIG. 3 is a front view of a computer peripheral device 300 according to another embodiment of the present invention. Computer device 300 is a Smartphone like device 100 described earlier except that the device has been architected with physical mouse controls that operate in the same way as a standard computer mouse. Device 300 also has computer touch screen 104 with familiar icons 106 and a graphical keypad 105. The physical mouse controls are a right click button 302, a scrolling wheel 303, and a left click button 301.

In this example a user may still invoke icon 112 on touch screen 104 in order to activate the device as a computer mouse. In an embodiment without touch screen 104, a mouse function activation button might be provided to activate Smartphone 300 when the device is wirelessly paired to a host computer or laptop. In this example, mouse control graphics may still appear on touch screen 104 so a user may choose from physical or virtual mouse controls.

FIG. 4 is a rear view of the computer peripheral device 300 of FIG. 3 or device 100 of FIG. 1 according to an embodiment of the present invention. Smartphone 300 has a digital camera represented in this example by a primary camera lens 400. A laser or optical motion detection device (sensor) 404 is provided for enabling mouse function as an optical computer mouse. In this example motion detection sensor 404 is strategically located adjacent to camera lens 400. Sensor 404 may be an optical sensor such as a laser sensor common to many digital computer mice. Positioning of sensor 404 allows the sensor to remain flush against a surface area when using device 300 as a computer mouse. This enables the sensor to effectively bounce light off the surface area (desktop, mouse pad, etc.) onto a semiconductor chip such as a Charged Coupled Device (CCD) or a Complementary Metal-Oxide Semiconductor (CMOS) tracking any movement detected and sending the images to an internal digital signal processor (DSP) for analysis.

Smartphone 300 has a pop-out stand 401 in this example. Pop-out stand 401 is attached to Smartphone 300 by a hinge 402. A latch mechanism 403 is provided to latch pop-out stand 401 in a retracted position on Smartphone 300. Stand 401 may be spring loaded so that when a user unlatches the stand using latch mechanism 403, the stand pops out automatically enabling a user to stand Smartphone 300 upright. A user may also use Smartphone 300 as a digital mouse with stand 401 in the out position providing a natural angle of use to help reduce tendon problems like carpal tunnel syndrome. A removable battery may be installed underneath pop out stand 401 and may be hidden by a removable cover plate (not illustrated). When a user activates computer mouse mode on Smartphone 300, the motion detection device powers on and digital mouse mode is activated until the user deactivates the feature using the touch screen or some switch (not illustrated) provided on the device and adapted for this purpose.

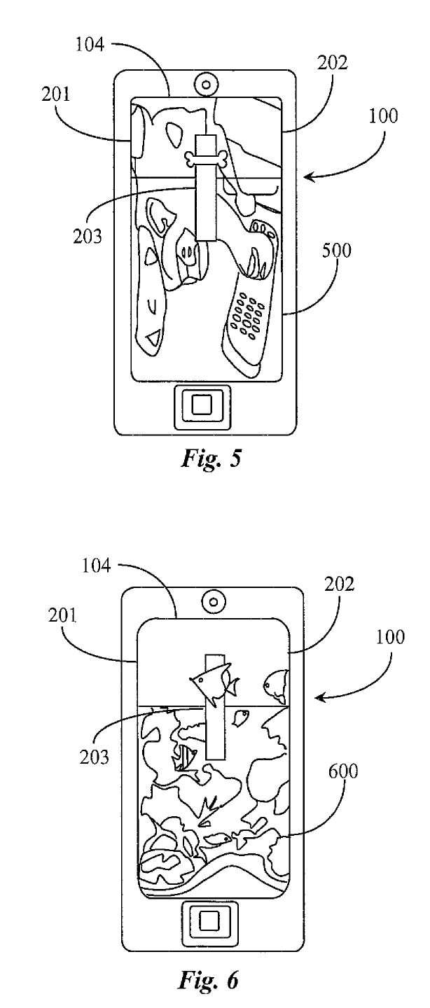

FIG. 5 is a front view of the computer peripheral device 100 of FIG. 1 exhibiting a decorative touch screen according to an embodiment of the present invention. Touch screen 104 is decorated in this example with a decorative layout or design 500 similar to a screen saver that covers a partial or the entire area of the touch screen. Design 500 may be one of many different designs that incorporate the mouse controls into the design including right click button 202, left click button 201, and scroll bar or wheel 203.

In one embodiment decorative design 500 is simply a graphical background or skin that incorporates the mouse control graphics in their original positions. However, in another embodiment design 500 may include code for redistributing or moving the mouse control graphics in a customized way that appeals more to the user.

FIG. 6 is a front view of computer peripheral device 100 of FIG. 1 exhibiting a custom decorative touch screen 600 according to an embodiment of the present invention. Design 600 is illustrated in this example as an alternative design for decorating the touch screen and graphical mouse controls 201, 202, ands 203. Many different themes may be provided as downloadable layouts that can be installed by selecting the layout from a pool of available layouts and installing the layout as the new touch screen design. In another embodiment a user may develop decorative touch screen designs using personal photographs, electronic drawings, or other computer art. In one embodiment animations may be provided wherein the computer mouse controls are visible in their original or reassigned positions but the rest of the screen contains constantly moving features such as fish swimming and so on. A user may download service-provided layouts or third party layouts

Many secondary features may be provided to the user such as the ability to rotate more than one touch screen design on the touch screen over a period of time. In one embodiment the touch screen designs are active animations that play while displayed on the touch screen. A user may be enabled to position mouse controls in a limited fashion and to change the color and hue of a touch screen decorative design. Application software provided on the Smartphone enables touch screen decoration management and configuration of touch screen settings. Different commercial designs may be made available to users through a server as a download or on a smart card as an upload. In one embodiment the user may obtain touch screen designs from a third party Web site or server wherein the designs follow popular themes suitable for all ages. Action figures, political themes, comedic renditions, and simple decorative scenes may be provided.

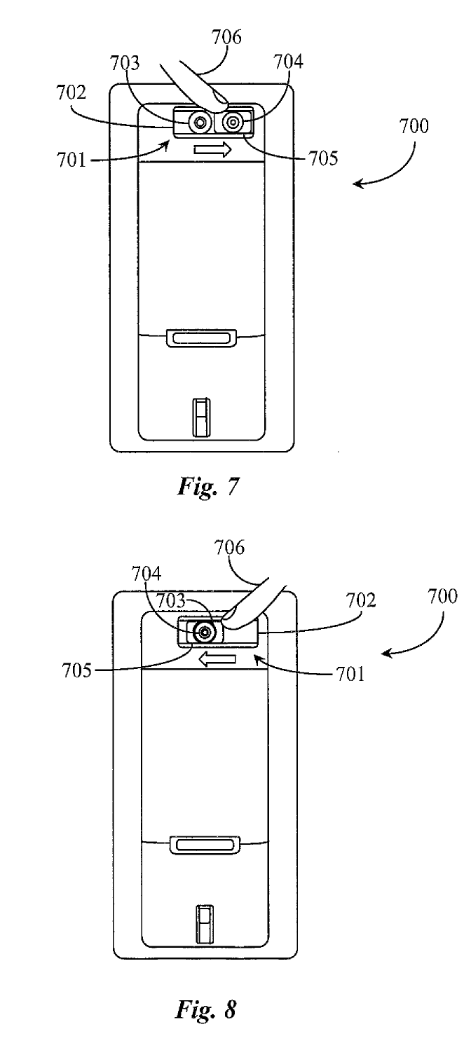

FIG. 7 is a rear view of a computer peripheral device 700 with a slidable optic lens in neutral position according to an embodiment of the present invention. Smartphone 700 includes an integrated optical system 701 that incorporates shared components. System 701 includes a fixed camera lens 703 and a fixed track 702. A convex optic lens 704 is provided and mounted on a slidable foot 705 installed in track 702. In this example a user represented by a user's finger 706 may slide lens 704 into the line of sight of camera lens 703 providing a lens stack that works to redirect light to a much shorter focal length for use as an optical mouse system. When the system is in digital mouse mode the camera is disabled. In this example, lens 704 is positioned to the right of primary camera lens 703 according to the direction of the arrow.

FIG. 8 is a rear view of computer peripheral device 700 of FIG. 7 with the slidable convex lens in alignment with the camera lens according to an embodiment of the present invention. In this example integrated optics system 701 is positioned for digital mouse mode. The user represented by finger 706 slides convex lens 704 into position by moving foot 705 according to the direction of the arrow, aligning it with the primary camera lens 703. In this case the mouse optics and camera optics system share the same image sensor (CCD, CMOS) and signal processor (DSP). Convex lens 704 is shaped to provide a very short focal length so that the image sensor senses movement at the level of the surface used as the mouse pad. In practical application, convex lens 704 is aligned with and resides over the top of primary lens 703 when in position for digital mousing.

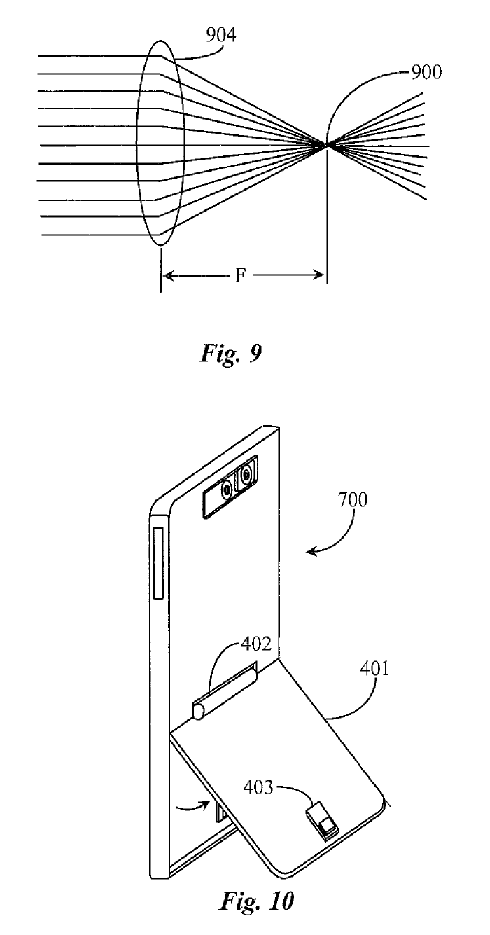

FIG. 9 is a block diagram illustrating convergence of light to a focal point after passing through a convex lens according to an embodiment of the present invention. To further illustrate the example described above, a convex lens 904 analogous to lens 704 of FIG. 8 is illustrated with light passing through it. The light (laser light), represented logically by multiple lines, is redirected to converge on a focal point 900. Focal point 900 represents the surface used as the mouse pad in digital mouse mode. A focal length F represents the distance between the convex lens and the focal point. When device 700 is in camera mode, convex lens 904 is moved back to its position adjacent the camera lens and the laser is powered off.

FIG. 10 is a rear perspective view of computer peripheral device 700 with a pop out stand according to an embodiment of the present invention. Device 700 has, in one embodiment, a pop out stand 401. Pop out stand 401 is hinged to device 700 by a hinge 402. A latching mechanism (slide lock) 403 is provided to secure the pop out stand in closed position until the feature is required in use. A user slides mechanism 403 down to cause the pop out stand 401 to release under spring tension and to pop out in the direction of the illustrated arrow to form a stand for device 700. The distance that stand 401 travels when released may be a calibrated distance in one embodiment.

A user may stand device 700 upright in a substantially vertical using pop out stand 401. In this way the user has hands free video conferencing capability and other similar uses. In one embodiment pop out stand 401 is released to pop out in digital mouse mode to function as an angle creation device that produces and maintains an angle whereby the back end of device 700 is raised off of the mouse pad surface according to the stated angle. A user may use the mouse with the pop out stand open or closed.

In one embodiment pop out stand 401 may be used to create an angle of rest when device 700 is used as a mouse. The angle created relieves pressure on a user's wrist when using the device as a computer mouse helping to reduce the risk of developing carpal tunnel. Pop out stand 401 may be manufactured of a durable polymer. One or more spring-tension mechanisms (not illustrated) may be assumed present in this example for controlling the movement of stand 401 when being used. In one embodiment pop out stand 401 covers a second removable plate that covers a battery compartment.

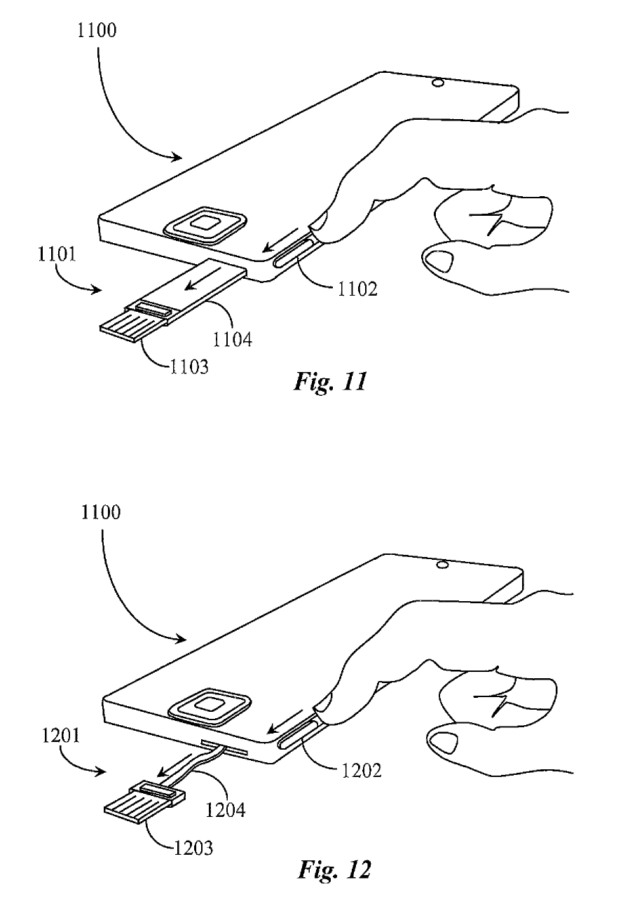

FIG. 11 is a perspective view of a computer peripheral device 100 with a flexible USB connector attached according to an embodiment of the present invention. Device 1100 includes a retractable USB interface 1101. USB interface 1101 includes a USB connector 1103 attached to a flexible USB neck 1104. USB connector 1101 is a high-speed connector in a preferred embodiment. USB neck 1104 may be manufactured of a resilient polymer that contains flexible USB leads to the USB connector attached at the open end.

A retraction lever 1102 is provided on the side wall of device 1100 for the purpose of extending the normally hidden USB flex-connector 1101 to a point where USB connector 1103 may be easily plugged into a USB port on a host computer. The flexibility of USB neck 1104 is such that USB coupling may be achieved without placing and stress on the USB/Port connection. A user may hide USB flex-connector 1101 from view by moving lever 1102 in the opposite direction from that illustrated thereby retracting USB flex-connector 1101 back into device 1100.

FIG. 12 is a perspective view of the computer peripheral device 1100 of FIG. 11 with a flexible USB connector according to another embodiment of the present invention. In this example device 1100 has a flexible USB connector 1201 installed. USB flex-connector 1201 comprises a USB high-speed connector 1203 attached to a flexible cord 1204 that may be installed on a spring-tensioned coil mechanism (not illustrated) that may be provided within device 1100. USB flex-connector 1201 is extendable from and retractable into device 1100 by manually pulling on the end of the connector while it is retracted about the coil mechanism provided within the device.

To extend USB connector head 1201 (uncoil) a user simply pulls the connector out from the device uncoiling cord 1204 from the coil mechanism. To prevent cord 1204 from retracting back into device 1100 via spring tension afforded the coil mechanism a user simply moves a friction lock lever 1202 provided on the side wall of device 1100 in the direction of the arrow activating the friction lock on cord 1204. In a preferred embodiment the end of USB connector 1203 does not fully retract into device 1100 remaining accessible to a user so that manual extension against spring tension in the coil mechanism is possible. USB flex-connector 1201, like USB flex connector 1101, enables stress free interfacing to the host computer system. No USB cables are required to couple device 1100 to a USB port on a host computing system.

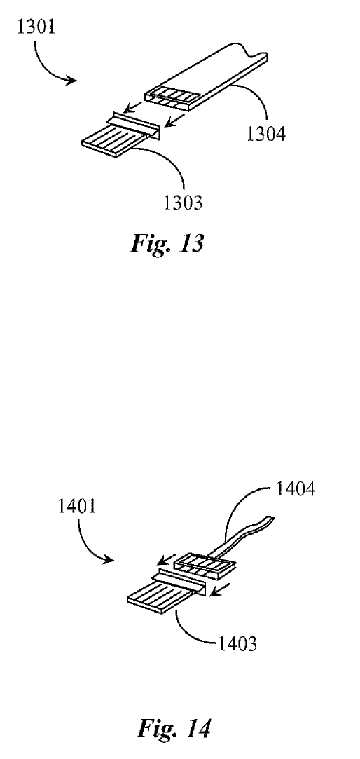

FIG. 13 is a perspective partial view of the USB flex connector of FIG. 11 with a detachable USB head that serves as a wireless USB transmitter according to an embodiment of the present invention. In this example USB flex-connector 1301 has a detachable USB connector head 1303 that may be plugged into a host system USB port to serve as a wireless USB transceiver such as a Bluetooth™ USB Dongle. USB connector head 1303 may be attached to USB flexible neck 1304 using a fast-connect coupler built onto the head that includes a spring loaded lock button that fits into a cutout strategically located on the USB flexible neck that prevents detachment of the USB head from the neck.

The lock button may be depressed to unlock the USB head from the USB flexible neck. When USB connector head 1301 is attached to the neck via the fast-connect coupler, it is connected electrically to the Smartphone via the metal contact points or leads located on the bottom of both the detachable USB connector and the inside housing of the coupling-mount. A user may detach USB connector head 1301 from neck 1304 by depressing the lock button to attain the clearance required for removal of the head. Once the USB connector head is detached from the flexible neck, it may be plugged into a USB port on any computing system and activated to wirelessly transmit and receive data from the Smartphone.

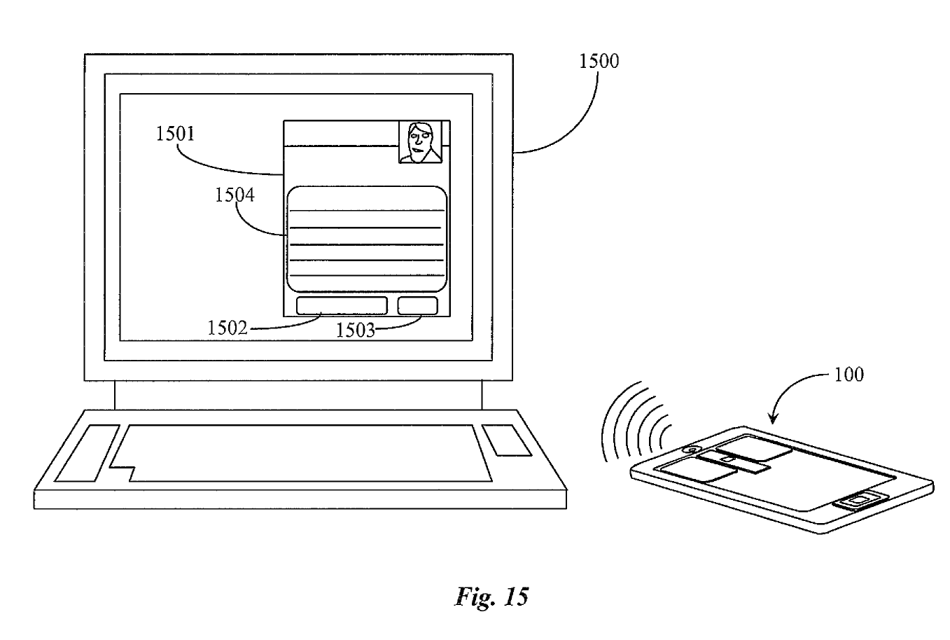

FIG. 14 is a partial perspective view of the flexible USB connector 1401 with a detachable USB head that serves as a wireless USB transmitter according to another embodiment of the present invention. In this example the fast-connect coupler is wired to the flexible cord 1404. USB head 1401 is detached in the same fashion described further above. The difference in the two embodiments amounts to the flexible neck in the first embodiment (FIG. 13) verses the flexible cord of FIG. 14. In both examples the USB head is attached using the same fast-connect coupler with a spring-loaded release button. It is noted here that there may be other fast-connect systems that may be adapted for the purpose of removing and re-attaching the USB head. In both embodiments the USB head functions as a wireless USB transceiver when detached from the flexible neck or cord.

FIG. 15 is a perspective view of a laptop computer running a graphical user interface (GUI) for accepting caller contact and identification data from the computer peripheral device of FIG. 1 according to an embodiment of the present invention. A laptop computer 1500 is illustrated in this example as a host system for Smartphone 100 in use as a wireless digital computer mouse. In one embodiment Smartphone 100 is adapted to receive incoming telephone calls and to automatically notify a user operating the phone as a digital mouse using a GUI illustrated herein as a GUI 1501 installed on the host computing system, in this case Laptop 1500.

GUI 1501 functions as a call management interface (CMI) that enables a user receiving a call on Smartphone 100 when operating the phone as a digital mouse to manage the call via the computing system. Available feature include call transfer features, text reply features, and accept or ignore features. In this example GUI 1501 is used to identify the caller by incorporating caller data that is transmitted from the Smartphone to the laptop computer during operation of the Smartphone in digital mouse mode. To achieve the transfer of relative data, an application is installed on Laptop 1500 that includes GUI 1501 among at least one other GUI that will be described later in this specification.

GUI 1501 includes a placeholder for a picture of the caller if a picture of the caller is available top the Smartphone. An indicator is provided to inform the user whether the caller is a potential new contact or an existing contact. Caller data 1504 is provided and displayed within GUI 1501 in an orderly fashion that might include such data as caller name and originating telephone number of the call. Other data included in the informational display might include caller address (if known), office telephone number (if known), home telephone number and mobile telephone number (if known), Voice over Internet Protocol (VoIP) name, for example, Skype™ name (if relevant), and email address (if known). Any caller data that may be known about the caller at the time of the incoming call is transmitted from the Smartphone wirelessly through the established wireless connection between the Smartphone and the laptop.

GUI 1501 contains an interactive contact add option 1502 for adding the caller data to a contact list or phonebook that might be hosted on the laptop computer such as an Outlook™ address book or the like. An interactive cancel button 1503 is also provided for canceling any add session contact. In one embodiment of the present invention callers that are familiar to the user are automatically added to selected computer-based contact lists. For brand new contacts the user may be prompted to decide whether to add caller contact data to a database.

In one embodiment potential contacts that call into Smartphone 100 have client applications installed so that robust caller data may be included with the incoming telephone call above and beyond typical caller data. In another embodiment GUI 1501 comprises a wirelessly transferred V-Card that displays caller-approved contact data that arrives with the incoming call. The data is then transferred to GUI 1501 and displayed in appropriate order.

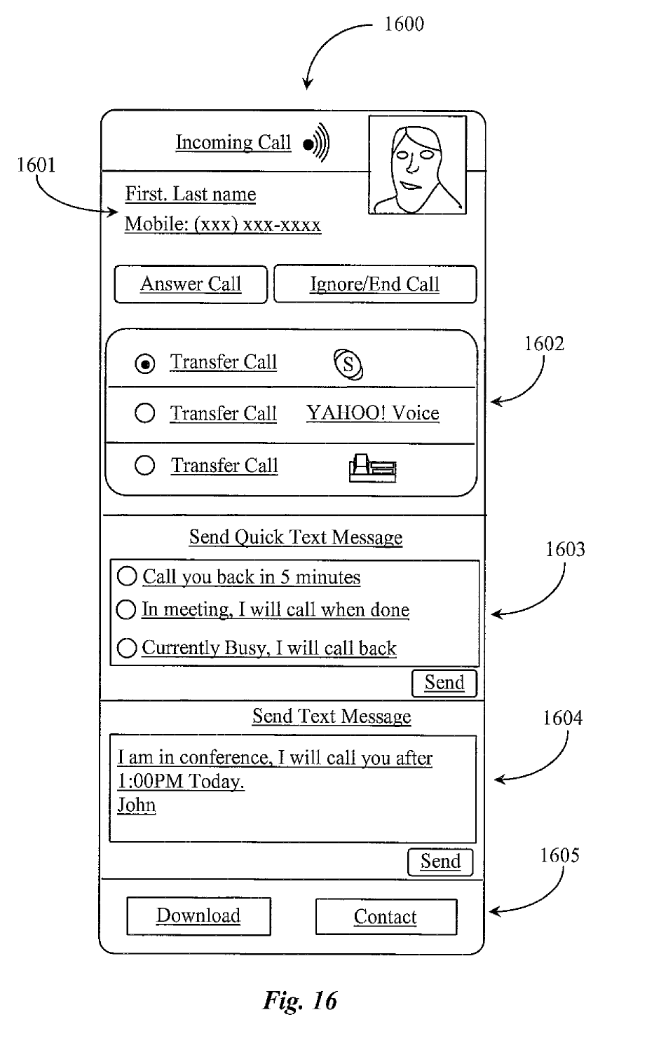

FIG. 16 is an exemplary screenshot of a GUI 1600 for managing incoming calls according to an embodiment of the present invention. GUI 1600, like GUI 1501 for receiving and displaying contact data from callers to the Smartphone, is installed on and executable from a host computing system being controlled by the Smartphone used as a digital mouse. Like GUI 1501, GUI 1600 is part of a general application that can be installed on any host computing system that will be paired with the computer peripheral device (Smartphone) of the present invention.

GUI 1600 includes a picture of the caller and the first and last name of the caller (caller identification). The originating telephone number may also be displayed in GUI 1600. An indicator such as a visual or visual/audio alert is provided within interface 1600 to alert the user of the incoming call. In one embodiment when an incoming call arrives at the Smartphone, GUI 1600 is executed as soon as the caller data is transmitted to the computer host via the wireless connection established between the systems. If the caller is a new contact then GUI 1501 may be executed along with GUI 1600.

GUI 1600 includes interactive call management options for answering the incoming call and for ignoring/ending the incoming call. GUI 1600 includes a call transfer option panel 1602 that provides at least one but more likely several interactive options for preprogrammed or real-time forwarding of the incoming telephone call to another communications device or program that can be used to answer the incoming call. In this example the first transfer option listed is for transferring the call to a VoIP interface installed on the host computer system like Skype™ for example. The next available option in option panel 1602 is to transfer the call to Yahoo Voice™. The next available transfer option in option panel 1602 is to transfer the incoming call to a landline-based telephone handset. A radio button is provided for each option to enable the user to select the desired option. In one embodiment the call transfer options may be preprogrammed so that the incoming calls automatically register as ringing events at the desired terminal. It is important to note herein that any communications device or program listed is paired wirelessly with the Smartphone like a Bluetooth™ headset for example. The call is still registered at the Smartphone for the duration of the call.

In one embodiment the call transfer may be accomplished by a take back and transfer operation in which the caller is put on hold and the transfer destination like a land-line telephone, for example, is dialed. When the user answers the land line, the system calls the Smartphone and connects to the call on hold bridging the call. A transfer send or activation button may be provided for realtime call forwarding or transfer where the option can be exercised on a call-by-call basis.

GUI 1600 includes an interactive options panel 1603 for replying to the caller with a text message sent back to the caller's telephone as a short message service (SMS) or other suitable text message types. The options in panel 1603 are reply options that use pre-crafted text messages or “quick text” that may be selected in real time or may be preprogrammed into the GUI by previous selection for any specific incoming call (based on caller ID) or for all incoming calls. GUI 1600 includes an interactive option 1604 for sending a manual text message in response to a ringing event that will not be answered.

In option panel 1603 each of the pre-crafted quick text messages includes a selection button for selecting which text message to send. A send button is provided for realtime application on a call-by call basis. In option panel 1604 a send button is provided for sending a manually crafted text message. An interactive options panel 1605 is provided within GUI 1600 for executing the contact interface to display all of the caller's contact data and for downloading any new information from the caller data arriving with the call to the GUI.

The software (SW) application that includes GUI 1501 and GUI 1600 may be distributed to subscribers that use the Smartphone of the present invention as a wireless computer mouse. However, operation of the device as a computer mouse is not a prerequisite for enabling the features of GUI 1501 or 1600. The practice of these features may be enabled through any wireless communication interface between the Smartphone and a computer appliance running the SW. In one embodiment GUI 1501 and GUI 1600 are packaged as a single executable GUI instead of two separately executable GUIs.

If a user prefers answering an incoming call directly through the Smartphone, the GUI will not interfere with this process. The user may answer any incoming call directly through the handset or any paired device like a headset or earpiece paired with the Smartphone (wireless headsets also work with the VoIP Programs).

Referring now back to FIG. 15, if a new caller is calling for the first time, the Smartphone SW automatically asks the user if they would like to add the new caller's contact information, such as their name and telephone number. If the user chooses to add the information then it will automatically be added to their Smartphone's address book and to the user's contact manager program on their computer, such as Microsoft Outlook™ or any other contact manager or address book software the user has installed on the Smartphone and/or host computer.

However, if a new caller is calling from another Smartphone with the same software, the Smartphone SW through GUI 1600 automatically prompts the user to add the new caller's dynamic contact card information. The data contained in the Smartphone's dynamic contact card is much more robust and contains additional information uploaded by the user, such as the user's name, telephone number, photo of the user, work and/or home address, email addresses, VoIP user names, etc. This data can be transferred with each call, allowing other users of the Smartphone software to share this robust information with one another. When a new caller is identified as a Smartphone user with a dynamic contact card then the user can add the caller which will simultaneously update all the appropriate software programs on the user's computer, related to the incoming data, such as the user's contact manager programs and VoIP programs. The data contained in each dynamic contact card is chosen by the user. A user can also create several different dynamic contact cards for different types of phone call recipients. For example, the user could create a dynamic contact card for their friends and family and one for business.

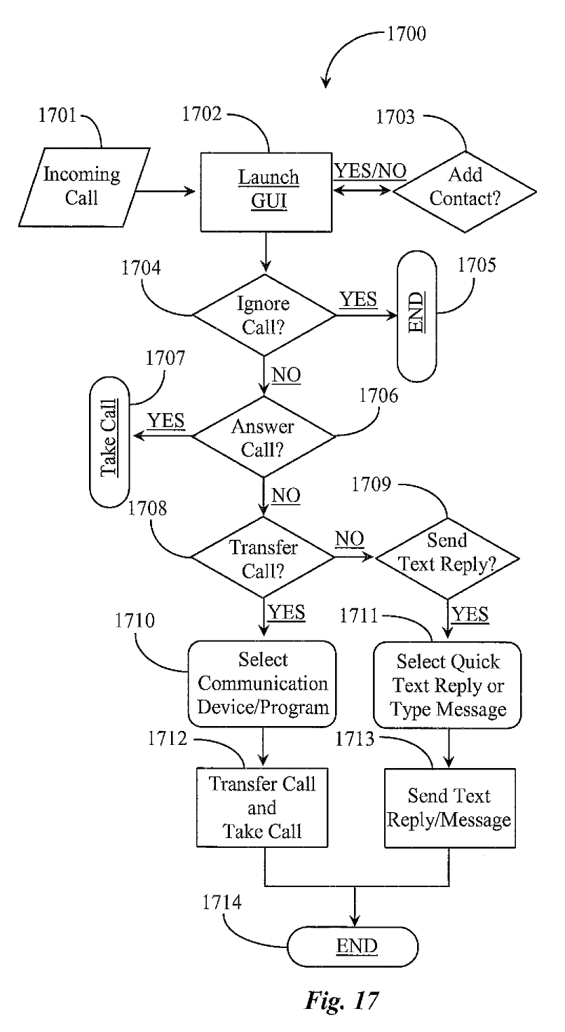

FIG. 17 is a process flow chart illustrating steps 1700 for managing an incoming call to a computer peripheral device on a host computer according to an embodiment of the present invention. At step 1701, an incoming call arrives at a Smartphone as a ringing event. It is presumed in this process that the Smartphone receiving the call is wirelessly paired to at least one host computing system running SW including the GUIs previously described.

At step 1702 communication of the call event to the host computer system causes the appropriate GUI or GUIs to execute. At step 1703 the SW prompt the user if he or she would like to add the caller's contact information from their dynamic smart card. Step 1703 may not occur if the caller's contact data is already known to the host computer system. At step 1704, the user may decide whether to ignore the call. If the user decides to ignore the call at step 1704, then the process may end for that call at step 1705 with no further action required.

If the user decides not to ignore the call at step 1704, the process moves to step 1706 where the user may decide whether to answer the call. If the user decides to answer the call at step 1706, then the user may pickup the call at step 1707 using the Smartphone or a headset or a handset wirelessly paired with the Smartphone. The user may also pick up the call using a VoIP program if it is preconfigured for answering the call. If the user decides not to answer the call directly at step 1706 then the user may decide if the call should be transferred in step 1708. If the user decides not to transfer the call at step 1708, the user may be prompted with an option to send a text reply back to the caller at step 1709. If the user decides not to send a text reply then the call is ignored by default. If the user decides to send a text reply at step 1709, then the process branches to step 1711 where the user may send a quick text message or a manually typed text message to the caller. In one embodiment the quick text option is preconfigured to automatically occur for specific callers or for all callers.

At step 1713 the user sends the text reply message in a realtime application. The process branch then ends at step 1714 for that caller. If the user decides to transfer the call to another device VoIP program, then at step 1710 the user selects a communication device or program listed in the options panel. Transfer to a specific program or device may also be a preconfigured option for specific callers or for all callers. At step 1712 in a realtime application, the user transfers the call and takes the call using the selected device or program. The process branch then ends at step 1714.

It will be apparent to one with skill in the art that the process illustrated by steps 1700 may include more of fewer steps without departing from the spirit and scope of the present invention. Steps 1700 may also be reordered from their present order without departing from the spirit and scope of the present invention. For example, decision steps 1704, 1706, and 1708 may be reordered without affecting the overall process.

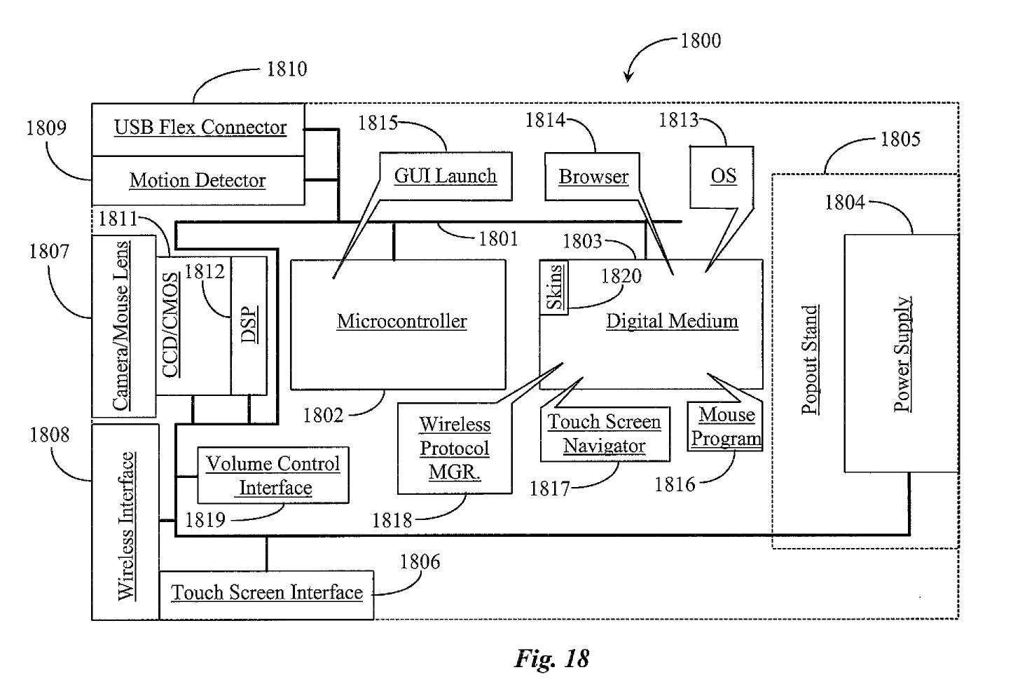

FIG. 18 is a block diagram illustrating basic components 1800 of a computer peripheral device adapted for provision of computer control input according to an embodiment of the present invention. Electronic components 1800 may be included in a Smartphone of the present invention several versions of which have already been described. Some of components 1800 are optional components and are not necessarily required in order to practice the present invention.

An internal communication and control BUS structure 1801 is provided within the Smartphone of the present invention and adapted to provide communication between, command distribution to, and power sharing to all of the included components. The Smartphone has a power supply 1804 connected to BUS 1801. Power supply 1804 may be a rechargeable battery typical of generation 3 and 4 (G3, G4) Smartphone. A microcontroller 1802 is provided within the device and is adapted for processing information and task performance.

The Smartphone has a digital medium 1803 provided therein and connected to BUS 1801. Digital medium 1803 is adapted to store data and executable SW programs used by the phone. In addition, the appropriate mix of volatile and non-volatile memory may be included in or accessible to the microcontroller. In this example, a pop out stand 1805 is illustrated as a broken rectangular structure located over the battery compartment of the device.

A touch screen interface 1806 is provided and is connected to BUS 1801. Touch screen interface 1806 includes all of the components including circuitry fro enabling a touch screen display of the device. The Smartphone of the invention includes a camera lens and circuitry and optionally a mouse lens (convex lens for reducing focal length) and associated hardware 1807. In this embodiment there is a single shared CCD or CMOS image sensor 1811 and a single shared DSP chip 1812 for processing data from the camera function and for processing data from the mouse function. In one embodiment two separate and dedicated systems are provided, for example, one set of optics, image sensor and DSP for the camera, and one set of optics, image sensor and DSP for the optical mouse function. CCD/CMOS 1811 and DSP 1812 are connected to BUS 1801. A motion detector (laser-based) 1809 is provided within the Smartphone in an embodiment that includes separate optics for mouse function.

A wireless interface transceiver 1808 is provided within the Smartphone and connected to BUS 1801 and includes all of the circuitry for enabling wireless paring with external devices including a host computing system. In this example a USB flex-connector is provided within the Smartphone and connected to BUS 1801. USB connector 1810 includes all of the required circuitry and connecting leads to enable docked and wireless USB communication with a computer host system.

In this embodiment microcontroller 1802 contains or has access to a command interface 1815 for launching a GUI installed on a host computing system, the command propagated to the host through wireless communication. When a call arrives at the Smartphone while it is being used as a computer mouse, the GUI will execute on the host computer to enable the user to perform contact data acquisition and call management of the call without interrupting the mousing function of the Smartphone.

Digital medium 1803 supports an operating system (OS) 1813 that is adapted to run SW programs and to perform other computing tasks. Components 1800 include a Web browser 1814 for accessing and browsing the Internet. Mouse SW program 1816 is provided to digital medium 1803 as an executable program for enabling digital mouse function. Digital medium supports a touch screen navigation program in one optional embodiment. Touch screen navigation SW 1817 enable the touch screen on the Smartphone to be used to control the computer display screen on a host computing system. In this optional embodiment the Smartphone can be used to navigate computer OS and SW programs without activating the device as a digital mouse. Also in this embodiment the user may manipulate programs on the host computer by manipulating selected icons representing computer shortcuts to programs and features available on the host computer. Digital medium 1803 supports a wireless protocol manager application (SW) that is adapted to enable the user to pair with external devices and to select which wireless technology (if more than one is installed) to use to pair with the external device or devices including a computer host system.

In one embodiment the Smartphone of the present invention has a volume control interface 1819 connected to BUS 1801. Volume control interface 1819 is adapted to enable the Smartphone to automatically turn down or mute the volume of any media device or system paired with the Smartphone of the present invention. Digital medium 1820 may also be used to store accessories like graphical decorative backgrounds or “skins” used for decoration of the touch screen of the Smartphone.

Other programs and features may be provided to the Smartphone of the present invention thus including them in components 1800 without departing from the spirit and scope of the present invention. The Smartphone of the present invention has been described relative to various versions that may differ from one another physically and with respect to SW and available features. Therefore, it will be apparent to one with skill in the art that the computer peripheral communication and computer input system of the invention may be provided using some or all of the mentioned features and components without departing from the spirit and scope of the present invention. It will also be apparent to the skilled artisan that the embodiments described above are specific examples of a single broader invention which may have greater scope than any of the singular descriptions taught. There may be many alterations made in the descriptions without departing from the spirit and scope of the present invention.

What is claimed is:

1. A computer peripheral device for providing a communication terminal and computer control input comprising;
a digital medium for storing data and software;
a processor for controlling computing functions;
a power source;
a motion detection sensor;
communication software residing on and executable from the digital medium;
computing input device software residing on and executable from the digital medium;
a user interface for enabling user control and task performance; and
a wireless transceiver for enabling wireless communication.

2. The computer peripheral device of claim 1 wherein the computing input device software enables a wireless mouse feature for operating a host computer.

3. The computer peripheral device of claim 1 wherein the communication software enables cellular telephony and Internet navigation.

4. The computer peripheral device of claim 2 wherein the user interface is a touch screen.

5. The computer peripheral device of claim 1 further including at least two physical mouse-click buttons and a scroll button.

6. The computer peripheral device of claim 1 further including a retractable universal serial bus connector.

7. The computer peripheral device of claim 6 wherein the USB connecter is detachable from the device for use as a USB wireless transmitter.

8. The computer peripheral device of claim 1 further comprising a digital camera device.

9. The computer peripheral device of claim 8 wherein the motion detection device and the digital camera device share one or more components.

10. The computer peripheral device of claim 4 wherein host computing application command shortcuts are present and operate from the touch screen.

11. The computer peripheral device of claim 4 wherein the touch screen supports a graphic simulation of the physical controls of a computer mouse, the graphics operable to provide computing input.

12. The computer peripheral device of claim 11 wherein decorative graphics residing on the digital medium can be used to dress the graphic simulation of the computer mouse controls on the touch screen.

13. The computer peripheral device of claim 1 further comprising a pop-out stand.

14. The computer peripheral device of claim 4 wherein word processing command shortcuts can be placed on the touch screen and may be operated to perform tasks within a word processing application running on a connected computing system.

15. The computer peripheral device of claim 4 wherein multimedia device command shortcuts can be placed on the touch screen and may be operated to perform tasks relative to multimedia devices operating as host devices.

16. The computer peripheral device of claim 15 wherein the tasks include but are not limited to controlling volume level, switching from speaker to headset, and switching play from one multimedia device to another multimedia device.

17. The computer peripheral device of claim 4 wherein the touch screen mirrors the active monitor display of a host computing device enabling touch screen navigation of the computer via the touch screen.

18. The computer peripheral device of claim 1 further including a separate software program installable on the host computer for detecting incoming calls to the computer peripheral device and changing volume settings of multimedia devices to accommodate the call.

19. The computer peripheral device of claim 8 wherein the digital camera device includes an extra convex lens movable into the line of sight of the camera, the lens for shortening the focal length of the camera to read surface movement in mouse operation mode.

20. The computer peripheral device of claim 6 wherein the USB head is attached to one of a flexible, retractable neck or a retractable cord.
